(19) United States
(12) Patent Application Publication
(10) Pub. No.: US 2010/0046624 A1
(43) Pub. Date: Feb. 25, 2010

(54) METHOD AND APPARATUS FOR TRANSLATION MOTION STABILIZATION

(75) Inventors: Fitzgerald J. Archibald, Tamil Nadu (IN); Jayanth R. Rai, Bangalore (IN)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/505,231

(22) Filed: Jul. 17, 2009

Related U.S. Application Data
(60) Provisional application No. 61/090,287, filed on Aug. 20, 2008.

(51) Int. Cl. H04N 7/26

(52) U.S. Cl. 375/240.16; 375/E07.123

(57) ABSTRACT

A method and apparatus for translation motion stabilization. The method includes initializing clip bias estimation and programmable sequencer, calculating sum of absolute differences and sum of absolute differences derivatives, utilizing the clip bias estimation, programmable sequencer, sum of absolute differences and sum of absolute differences derivatives to estimate block motion vector, frame motion vector and unwanted motion vector, and compensating for motion to produce a stabilized video

This application claims priority to U.S. Provisional Application No. 61/090,287, entitled “TRANSLATIONAL MOTION STABILIZATION FOR EMBEDDED VIDEO APPLICATIONS,” filed Aug. 20, 2008, which is hereby incorporated by reference for all purposes.

### BACKGROUND OF THE INVENTION

1. Field of the Invention

Embodiments of the present invention generally relate to a method and apparatus for translation motion stabilization.

2. Description of the Related Art

Context-adaptive binary arithmetic coding (CABAC) is an efficient entropy coding technique used in image/video coding, i.e. H.264/MPEG-4 AVC. CABAC became a performance bottleneck for hardware decoders with the high-definition (HD) requirements. A solution to solve CABAC throughput problem is to parse multiple data units in parallel using multiple processors.

H.264, for example, defines slice structures to create independently decodable data units. The dependency of context models and parsing process inside a slice structure makes it difficult do multiple processor CABAC decoding below the slice layer. The maximum allowable slice size is equal to a picture in standards, such asm the H.264 standard. Therefore, decoders that rely on slice level parallelism should work on picture-level to handle this worst case scenario. Operating picture level introduces extra decoding delay and increases the memory bandwidth requirements.

“Entropy Slices” is an idea introduced for next-generation image/video coding standards, which defines data units that can be independently parsed by CABAC decoder. This approach also introduces limits on the size of entropy slices to enable low cost parallelism. However, an initial study of this method indicated 1.5%-7% bit-rate increase compared to not using slices. The performance degradation diminishes the advantage of using CABAC instead of using simple variable length coding (VLC) techniques.

There are two main reasons for the reduced performance. Firstly, the context model probability states used in CABAC are reset to an initial state at the beginning of each entropy slice. Model resets become more frequently as the entropy slice size gets smaller. Resetting frequently reduces probability model accuracy and impedes compression efficiency. Secondly the selection of context models for some syntax elements, such as motion vector difference; rely on using information from neighboring blocks. The top neighbors of blocks in the upper row of slices are not available. As the slice size is reduces the percentage of blocks in the top row will increase, therefore, the context models that rely on neighbor data will be less accurate.

Therefore, there is a need for a method and/or apparatus for improving the compression performance of “Entropy Slices”.

### SUMMARY OF THE INVENTION

Embodiments of the present invention relate to a method and apparatus for translation motion stabilization. The method includes initializing clip bias estimation and programmable sequencer, calculating sum of absolute differences and sum of absolute differences derivatives, utilizing the clip bias estimation, programmable sequencer, sum of absolute differences and sum of absolute differences derivatives to estimate block motion vector, frame motion vector and unwanted motion vector, and compensating for motion to produce a stabilized video.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. In this application, a computer readable processor is any medium accessible by a computer for saving, writing, archiving, executing and/or accessing data. Furthermore, the method described herein may be coupled to a processing unit, wherein said processing unit is capable of performing the method.

FIG. 1 is an exemplary embodiment depicting block in a frame;

FIG. 2 is an exemplary embodiment depicting a horizontal boundary signal computation;

FIG. 3 is an exemplary embodiment depicting a vertical boundary signal computation;

FIG. 4 is an exemplary embodiment depicting a waveform of boundary signal;

FIG. 5 is an exemplary embodiment depicting a horizontal sum of absolute differences computation;

FIG. 6 is an exemplary embodiment depicting a vertical sum of absolute differences computation;

FIG. 7 is an exemplary embodiment depicting a waveforms of sum of absolute differences and its derivatives;

FIG. 8 is an exemplary embodiment depicting a block diagram of base motion estimation;

FIG. 9 is an exemplary embodiment depicting a waveforms of base motion vector;

FIG. 10 is an exemplary block diagram depicting an embodiment for a frame motion estimation;

FIG. 11 is an exemplary embodiment depicting a raw histogram;

FIG. 12 is an exemplary embodiment depicting a windowed histogram;

FIG. 13 is an exemplary embodiment depicting accumulated histogram;

FIG. 14 is an exemplary embodiment depicting a frame motion vector estimation using histogram;

FIG. 15 is an exemplary embodiment depicting a spurious frame motion vector elimination using base motion vector spread;

FIG. 16 is an exemplary embodiment depicting a frame motion vector with spurious data handling;

FIG. 17 is an exemplary block diagram of an embodiment depicting a unwanted motion estimation;

FIG. 18 is an exemplary flow diagram for a unwanted motion estimation method;

FIG. 19 is an exemplary embodiment depicting a unwanted motion estimation waveforms;

FIG. 20 is an exemplary embodiment depicting a magnitude response of filter bank;

FIG. 21 is an exemplary embodiment depicting a low frequency bias waveform;

FIG. 22 is an exemplary flow diagram depicting an embodiment of method for compensation co-ordinate estimation and clip bias estimation;

FIG. 23 is an exemplary embodiment depicting a motion compensation by cropping;

FIG. 24 is an exemplary block diagram depicting embodiment of a hardware-software partition;

FIG. 25 is an exemplary block diagram depicting embodiment of an image stabilizer apparatus;

FIG. 26 is an exemplary embodiment depicting of a Image stabilizer sequence diagram;

FIG. 27 is an exemplary flow diagram depicting embodiment of a method for VS; and

FIG. 28 is an exemplary embodiment depicting of an image stream.

### DETAILED DESCRIPTION

Image sequences recorded by Digital Suntil Camera (DSC) or Digital Camcorder typically have unwanted frame motion due to unintentional shaking of camera. The unwanted motion can be translational (vertical and/or horizontal) or rotational. The sequences may have desired frame motion as in panning shots. The purpose of image stabilization is to remove unwanted motion from the sequences being recorded or captured.

Stabilization may also be performed while playback of captured images. The vertical axis tends to have more jitter generally due to gravity affecting camera held by hand. The horizontal motion is prominent when the image is shot from moving vehicles. This paper provides an image stabilization algorithm for compensating or eliminating translational motion by estimating frame motion estimation from block.

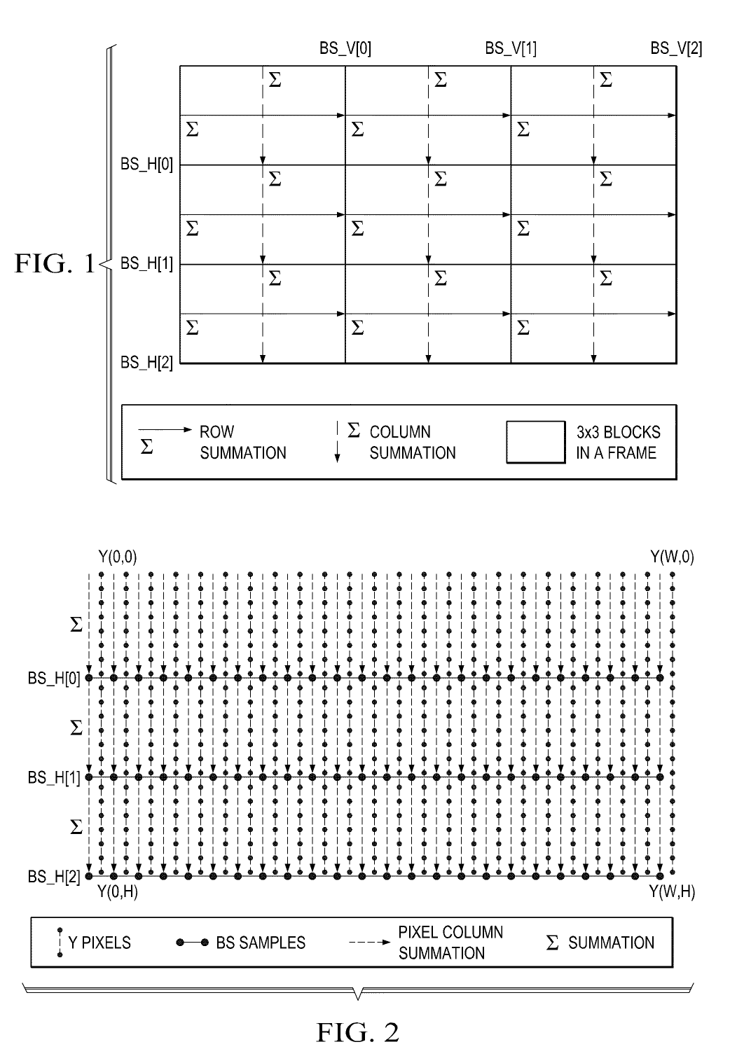

FIG. 1 is an exemplary embodiment depicting block in a frame 100. The image stabilization algorithm consists of: 1) Block Motion Estimation (BME) 2) Frame Motion Estimation (FME) 3) Unwanted motion estimation (UME) 4) Frame Motion Compensation (FMC). The computations need to be performed for horizontal and vertical axes. The Boundary Signal computation (BSC) and Sum of Absolute Differences (SAD) computations used in BME are computationally intensive. The computational complexity of FMC depends on technique used for compensation. The frame 100 is divided vertically and horizontally to produce blocks. Only luma (Y) sample of frames are used for BSC and sum of absolute differences computations used in Block motion.

Base motion vector (BMV) and frame motion vector (FMV) estimation. The reason for using Y is because of the availability of Y samples for all pixels in a frame and texture information contained in them. FIG. 1 illustrates, by example, 3×3 division of frame 100 resulting in 9 blocks. This division is carried out for getting block motion vectors, rather than frame vector. If the frame 100 has a moving object, only few of the BMV will be incorrect. Thus, this division helps in finding frame motion vector even in the presence of moving objects in the frames being stabilized. The number of blocks in a frame can equal as much as the number of Y pixels.

The smaller the block dimension, the higher the computational load for BMV and frame motion vector computation. The division of 3×3 is more optimal in the sense there is a centre block with focus on object of interest and 8 boundary blocks. The division of 5×5 is good for larger frame sizes since there are 9 inside blocks and 16 boundary blocks.

The computational steps in BME are BSC, sum of absolute differences and derivatives computation and Motion Estimation (ME). Luma (Y) samples in a frame are used for Boundary Signal (BS) calculation. The BS is used for computing sum of absolute differences vector. The sum of absolute differences and derivative vectors are used for estimating Motion Vector (MV) for each of the blocks in the frame.

BS is the 1-D vector representing the texture information contained in 2-D frame. Horizontal BS (BS_{H}) is computed by summation of all pixels along a column, as given by (1) for entire frame (1×1). Thus, the length of the boundary signal will equal the width of the frame (W). FIG. 2 shows BS_{H} computation in case of 3×3 division. In case of 3×3 block division of the frame, the summation is performed for each block. The frame is divided into 3 equal divisions horizontally. The summation is performed for each horizontal division. This results in 3 BS_{H} signals of length equaling to W. Each BS_{H} can be divided into 3 equal pieces to produce 1 BS_{H} signal per block.

$$B {S}_{H} ( h ) = {\sum }_{v = 0}^{v = H} Y ( h , v ) , where h = 0 , 1 , 2 , … , W \qquad ( 1 )$$

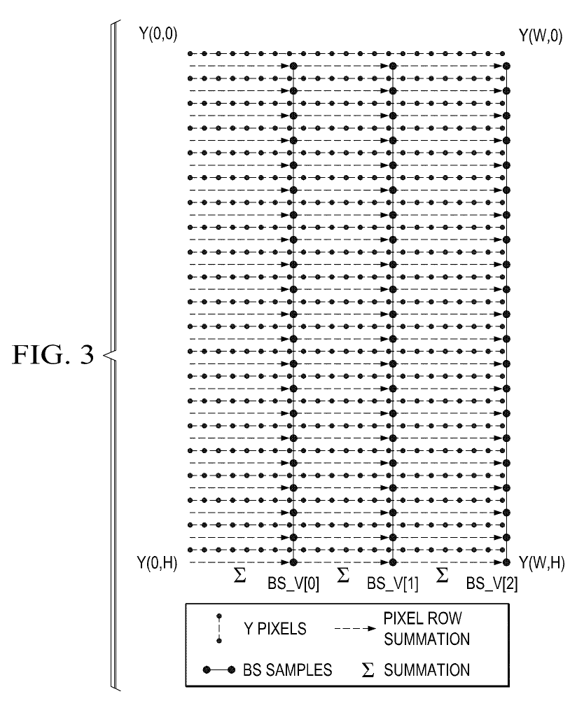

Vertical BS (BS_{V}) is computed similar to BS_{H}. The summation of pixels along row produces BS_{V} of length equal to height of frame (H), as given by (2). The image is divided vertically into 3 equal pieces. The row summation on each division produces 3 BS_{V}, as shown in FIG. 3. Each BS_{V} is divided into 3 equal pieces to produce 1 BS_{V} signal per block. Thus, there are 9 BS_{V} and 9 BS_{H} vectors.

$$B {S}_{V} ( v ) = {\sum }_{h = 0}^{h = W} Y ( h , v ) , where v = 0 , 1 , 2 , … , H \qquad ( 2 )$$

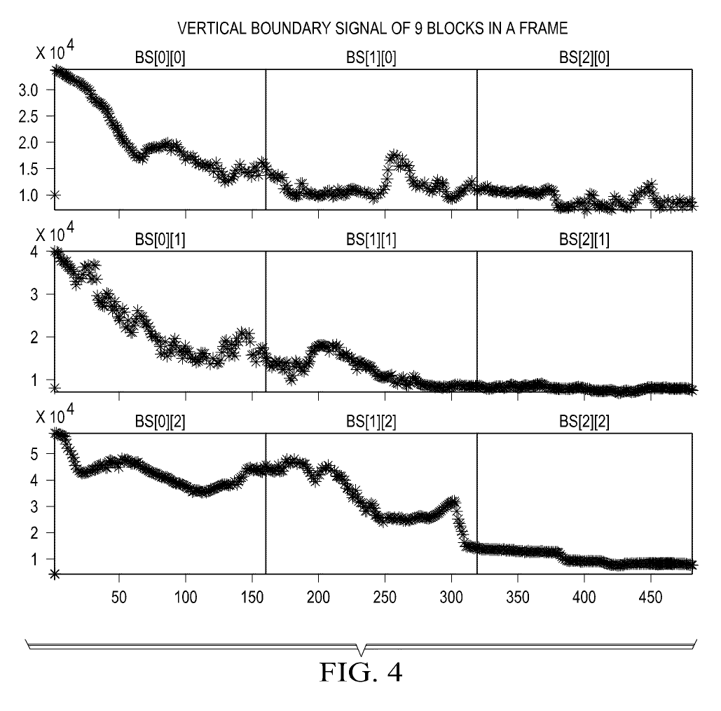

A practical example of boundary signal is provided in FIG. 4, which is an exemplary embodiment depicting a waveform of boundary signal.

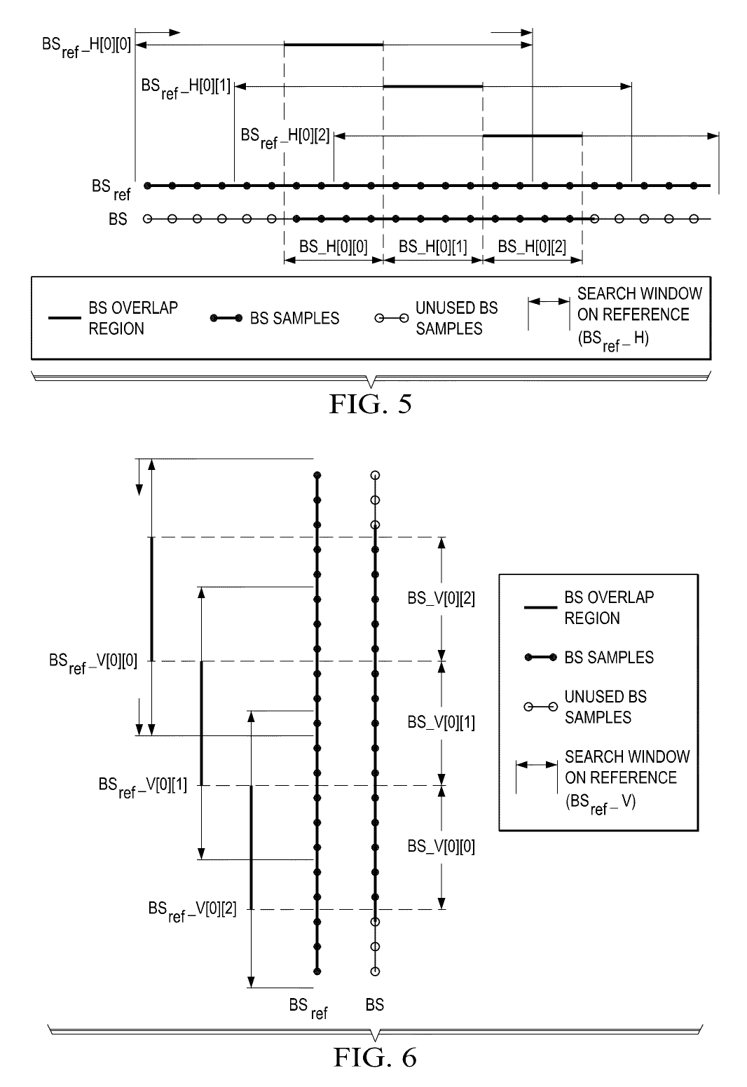

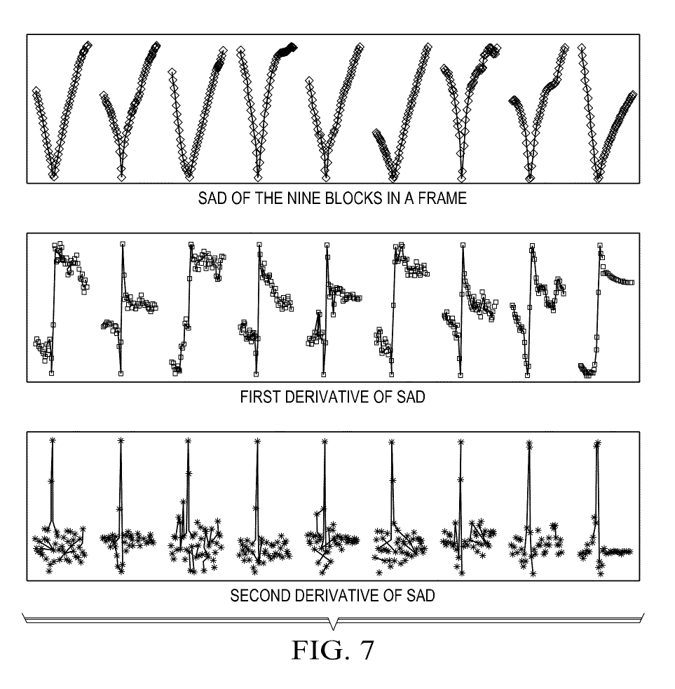

Sum of absolute Differences computation on 1-D BS results in a 1-D sum of absolute differences vector. sum of absolute differences computation may utilize reference (BS_{ref}) and current BS (BS). Previous frame BS is the reference BS for current frame. The current BS is slid on BS_{ref} in 1 sample steps. For each sliding position, summation is carried out on all absolute differences between reference and current BS samples, as given by (3). Sliding is carried out from negative maximum BMV (−BMVₘₐₓ) to positive maximum (+BMVₘₐₓ) position with respect to BS of length L_{BS}. This means the BS is shorter than BS_{ref} by 2*BMVₘₐₓ, as shown in FIGS. 5 and 6, which depict exemplary embodiments for horizontal and vertical sum of absolute differences computation, respectively.

$$SAD ( n ) = {\sum }_{n = - B M {V}_{max}}^{n = + B M {V}_{max}} {\sum }_{m = 0}^{m = {L}_{B S} - 2 \times B M {V}_{max}} \vert \begin{matrix}B {S}_{ref} ( m + n + B M {V}_{max} ) - \\ B S ( m + B M {V}_{max} )\end{matrix} \vert \qquad ( 3 )$$

sum of absolute differences vector is computed for both horizontal and vertical BS of each block in the frame. Thus there are 9 horizontal sum of absolute differences vectors (sum of absolute differences h) and 9 vertical sum of absolute differences vectors (sum of absolute differences v). In other words, 1 sum of absolute differences vector per BS vector is computed. The 3 horizontal and 3 vertical sum of absolute differences vector computations illustrated in FIGS. 5 and 6 respectively needs 2*BMVₘₐₓ search margin on edge of boundary signals BS for sliding. The inner vector can use the outer boundary signal samples for sliding.

The sum of absolute differences values may utilize 22 bit memory locations for 640×480 resolution with 3×3 blocks. The result can be shifted right to fit in 16 bit memory without any significant loss in BME capability. The amount of shift (rsh) is dynamically computed based on past frame maximum sum of absolute differences value as given in (4), (5) and (6). The sum of absolute differences values are right shifted by rsh and saturated to 2¹⁶−1 before storing in 16 bit memory.

estSADₘₐₓ=|SAD|ₘₐₓ (4)

rsh=rsh+1,if (estSADₘₐₓ≧2¹⁶−1) (5)

rsh=rsh−1,if (estSADₘₐₓ<2¹⁵−1) (6)

If automatic exposure or gain control is applied on input YUV frames, the boundary signals (reference and current) will vary in amplitude by a constant bias for correlated data. This variation will cause sum of absolute differences to detect the reference and current frame as uncorrelated data due to the non-linear nature of the building block in sum of absolute differences namely absolute computation. However, equal or proportional gain change (gain or exposure time) as applied to current frame can be applied to reference BS to circumvent this problem. Note that uncorrelated data problem due to variation in luma magnitude suntil causes problem in case of lighting change caused by shadows or obstructions in the light path for the same scene content.

The 1^{st} and 2^{nd} derivatives of sum of absolute differences are computed as in (7) and (8).

$$\begin{matrix}\frac{d}{d n} SAD = SAD ( n ) - SAD ( n - 1 ) , \\ where n = 1 , 2 , 3 , … , 2 * B M V max & ( 7 ) \\ \frac{{d}^{2}}{d {n}^{2}} SAD = \frac{d}{d n} SAD ( n ) - \frac{d}{d n} SAD ( n - 1 ) , \\ where n = 1 , 2 , 3 , … , 2 * B M V max - 1 & ( 8 )\end{matrix}$$

The derivatives are computed for both horizontal and vertical sum of absolute differences vectors. There is a 1^{st} and 2^{nd} derivative vector for each vertical and horizontal sum of absolute differences vector in a block. The example waveforms are shown in FIG. 7.

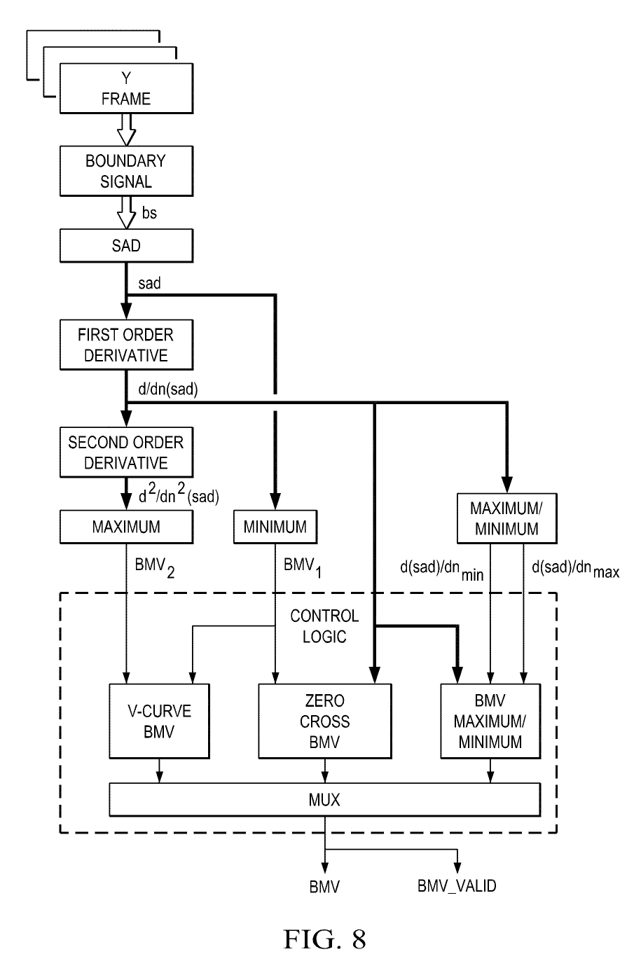

BMV computation relies on the nature of sum of absolute differences curves for correlated data. In case of highly correlated data, the sum of absolute differences vector will have a minimum at the best match position. On either side of this minimum, the correlation will gradually decrease resulting in increasing magnitude of sum of absolute differences values. If the relative motion between adjacent frame is higher than the search range (−BMV_{max to +}BMVₘₐₓ), then the sum of absolute differences vector may simple have negative or positive slope depending whether the motion is to right or to the left. This is because the best match position lies outside the search range. If the reference and current frame data are uncorrelated, then sum of absolute differences may have many minima (false minima). In some cases of uncorrelated data, the sum of absolute differences vector may even show a positive or negative slope line similar to the high motion case. Building blocks and data/control flow of BME stage is given in FIG. 8.

Step 1: If the distance between the positions on which sum of absolute differences reached minima (minsum of SAD pos) and 2^{nd} derivative reached maxima (maxsum of SAD2 pos) is within a threshold (2*BMVmax/12), the BMV for the block is estimated as the position of the 2^{nd} derivative maxima(max SAD 2pos).

Step 2: If BMV can not be determined using step 1, a window of region (2*BMVmax/5) is established in 1^{st} derivative of sum of absolute differences around the position on which sum of absolute differences reached minima. All the positions on which the 1^{st} derivative of sum of absolute differences transitions from negative to positive within this window are recorded. If the number of such transitions is unity and distance between the positions of this zero crossing (xingPos) and the sum of absolute differences minima are within a threshold (2*BMVmax/12), the BMV for the block is estimated as the position of the zero crossing.

Step 3: If step 1 and 2 does not yield a BMV, then the chance is that maybe BMV has reached maxima. The maxima and minima values in 1^{st} derivative of sum of absolute differences are added. If the sum is positive, a negative threshold of value equivalent to 10% of the maxima is established. Otherwise, a positive threshold of 10% of the minima is established. If all values in 1^{st} derivative of sum of absolute differences vector are below the threshold, BMV is on positive maxima (BMVₘₐₓ). If all the values in 1^{st} derivative of sum of absolute differences are above the threshold, BMV is on negative maxima (−BMVₘₐₓ).

Step 4: If steps 1, 2 and 3 failed to estimate BMV, BMV is marked as invalid. If the maximum and minimum value of sum of absolute differences is the same or within a threshold (i.e. either statically or dynamically estimated) then BMV is considered invalid. In this case the minimum sum of absolute differences is not an index of motion most probably.

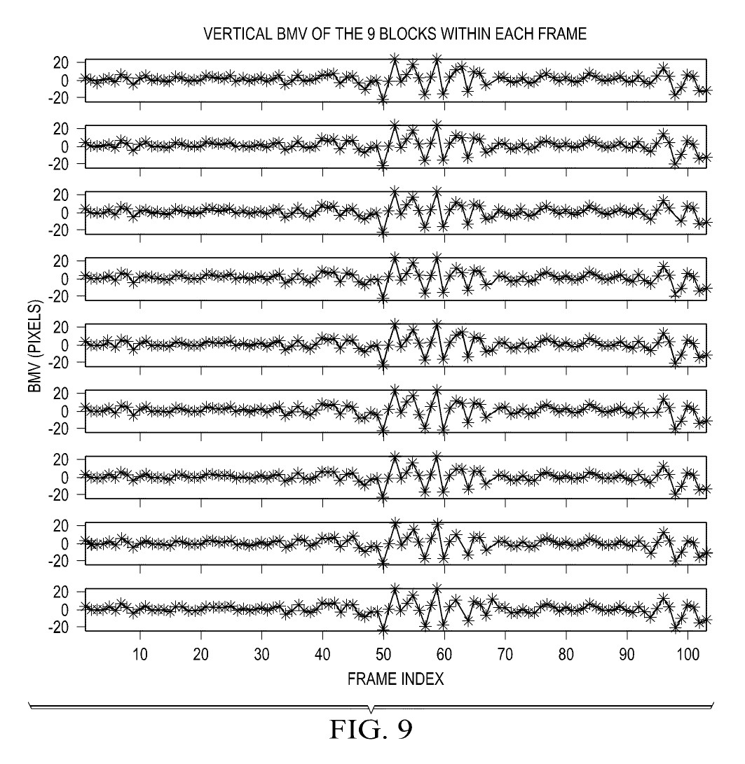

The steps 1 to 4 are performed for each block in a frame for both vertical and horizontal direction. The result from this stage is BMV and BMV validity in vertical and horizontal direction for each block within a frame. The BMV and its validity may be passed in to the application via interface to facilitate algorithms, such as, image stabilization. An example of BMV waveforms is shown in FIG. 9.

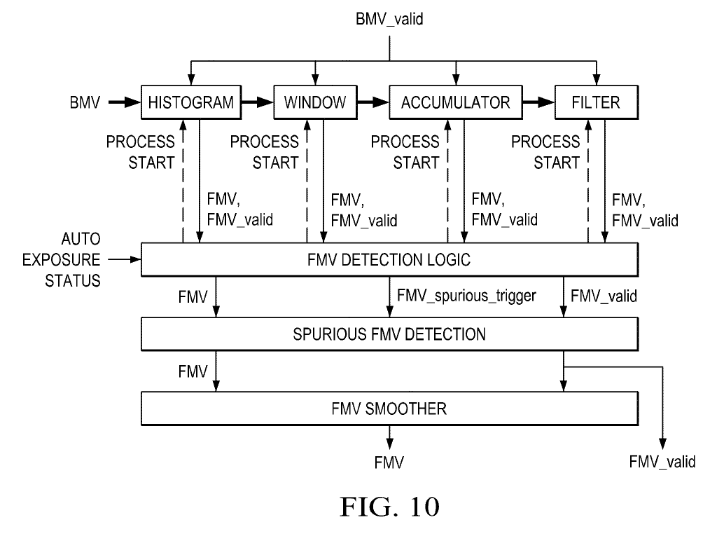

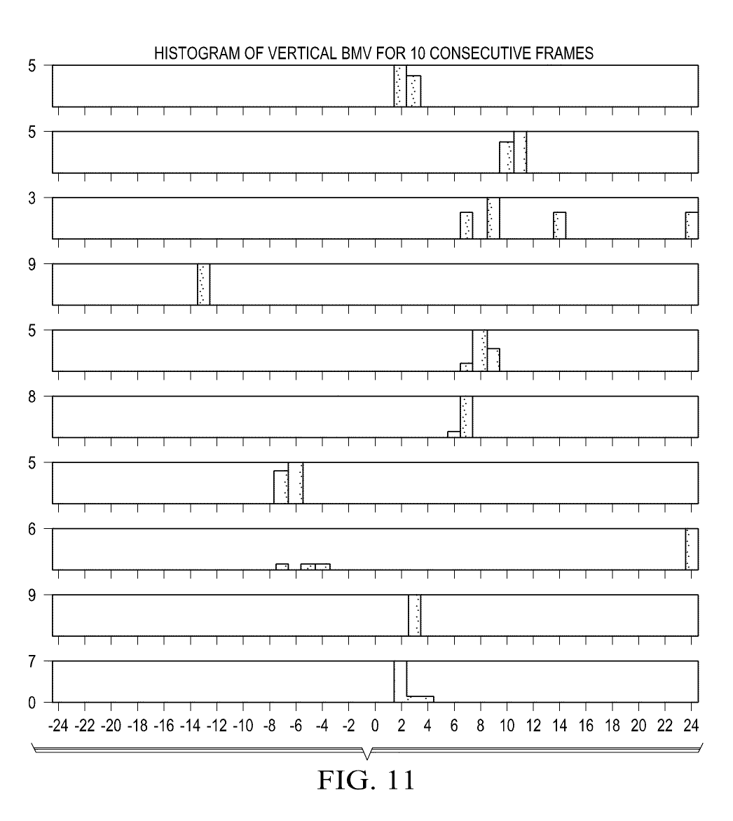

FME uses BMV of each block in a frame to estimate global or frame motion vector. The estimation step consists of raw histogram, windowed histogram, accumulated histogram, filtered histogram, frame motion vector computation, spurious frame motion vector detection, and frame motion vector smoothing as shown in FIG. 10. The histograms provide information for frame motion vector computer for estimating frame or global motion vector. In addition, the parameters from histogram are used by Spurious frame motion vector detector for isolating potential jitter introduced by the algorithm. The main causes for spurious values are due to scene change (uncorrelated data), Luma variation (shadows and auto exposure algorithms), and object motion across frames. The spurious frame motion vector detector validates whether the estimated frame motion vector is erroneous. The frame motion vector smoother minimizes the unwanted motion caused from valid to invalid transition and vice versa, when invalid frame motion vector are detected.

The x-axis of the histogram is BMV values. The y-axis of the histogram is the number of blocks in current frame that have the particular BMV value. Raw histogram example is given in FIG. 11.

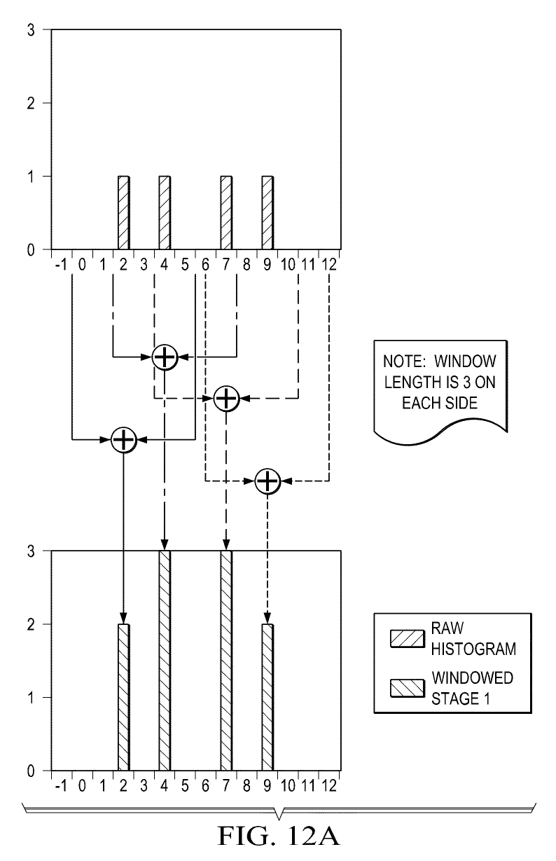

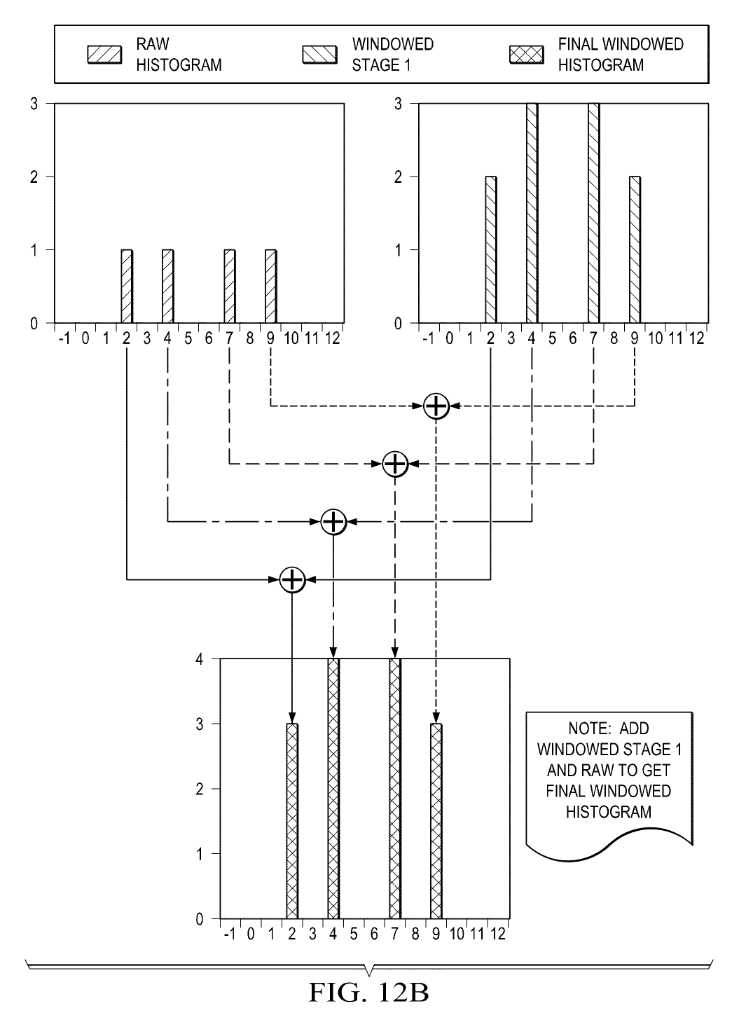

In windowed histogram, a window of pre-determined length is slide across the raw histogram. The BMV position which is at the center of the window is accumulated with all the histogram bars within the window. The accumulated value is added with the center bar in the window, to avoid neighborhood bars of different height resulting in equal bar length with windowing. On completion of sliding across the raw histogram, windowed histogram is generated. FIG. 12 is an example for windowed histogram computation procedure.

The largest bar in windowed histogram is selected as the center. A window is established with this center. The window length is same as in windowed histogram. All the bars within the window are accumulated to this center. Once accumulation is completed, the bars used in this accumulation process are excluded from further accumulation. In other words, the bars contribute in only one accumulation. The above mentioned procedure for accumulation is repeated until all bars are used for accumulation.

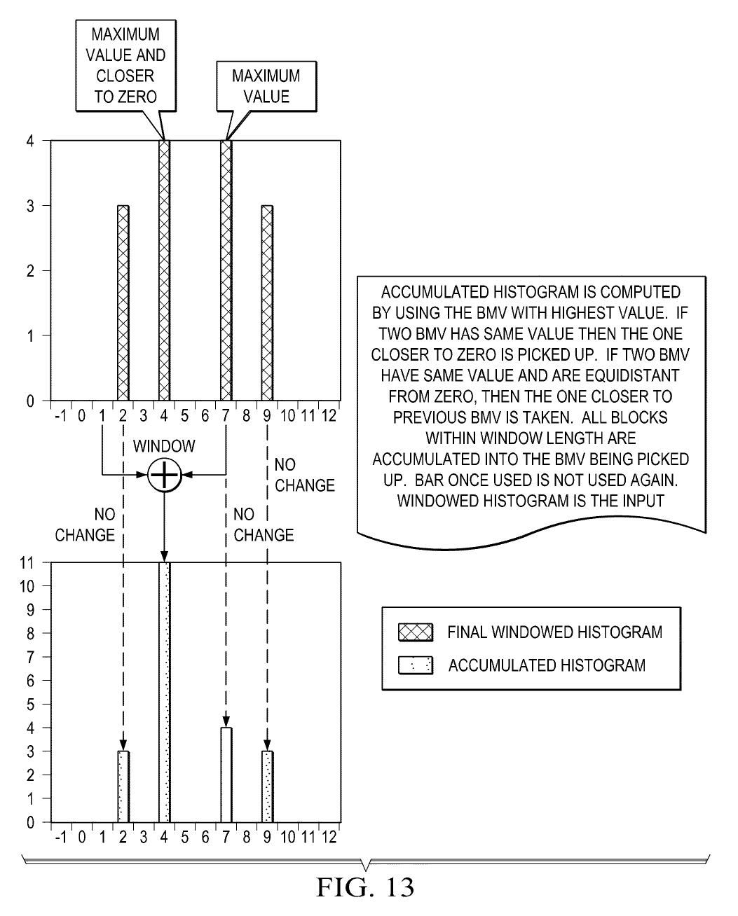

In case of two or more bars having same length and a center needs to be established, the bar closest to previous valid frame motion vector is selected as the center. In case two bars are of same distance from the previous valid frame motion vector, the frame motion vector closest to BMV value of zero is selected as the center. FIG. 13 is an example for accumulated histogram computation procedure.

The filtered histogram relies on past frame BMV validity status. A Finite Impulse Response (FIR) filter with coefficients b₀=2⁻¹, b₁=2⁻², b₂=2⁻³, b₃=2⁻⁴, and b₄=2⁻⁴

$$( Note \text{:} {\sum }_{k = 0}^{4} {b}_{k} = 1 )$$

is applied on BMV validity of each block in current frame and past 4 frames. The number of past frames used in filtering process can be increased or decreased as needed and the coefficients may be adjusted accordingly. The filter equation is given by (9). The filter result will have value between 0 and 1. The filter result of each block (blkld) is mapped against the corresponding BMV of the block in current frame. Steps in accumulated histogram are performed on this mapped result to yield filtered histogram.

$$B M {V}_{valid}^{filt} [ n ] [ blkId ] = {\sum }_{k = 0}^{4} {b}_{k} * B M {V}_{valid} [ n - k ] [ blkId ] , \\ where n is frame number and \\ blkId is blocks in a frame ( 0 … 8 ) \qquad ( 9 )$$

If there are any valid BMV in current frame, frame motion vector can be estimated using the results of histogram stages. In case of automatic exposure algorithm is active and gain change is not adjusted during sum of absolute differences computation, frame motion vector estimation is skipped since sum of absolute differences will not have a minima at the BMV position.

Step 1: If raw histogram has a single maxima bar with the maxima value (maxVal_{raw}) greater than the threshold (numBlk_{RawHistThr}=3) and the maxima bar value greater than or equal to the sum of all the other histogram bar values, then the BMV value on the maxima bar is picked as the frame motion vector of current frame. If maxVal_{raw} is less than or equal to one fourth the number of valid BMVs, no frame motion vector available from this step, and bmv_{range} is greater than or equal to bmv_{Thr}^{max} then the accumulated and filtered histogram based frame motion vector detection in step 3 and 4 are bypassed.

Step 2: In case raw histogram failed to yield a frame motion vector, the steps of frame motion vector detection is repeated on windowed histogram. The threshold value (numBlk_{WinHistThr}=6) is increased to accommodate for windowing procedure of the histogram.

Step 3: If raw and windowed histogram does not yield a frame motion vector, accumulated histogram is used for frame motion vector estimation. If there is a single maximum bar, the BMV corresponding to the maxima bar in the accumulated histogram is picked as the frame motion vector. If the histogram bar value is below a limit (numBlk_{AccHistThr}=12), a flag (spurious_{possible}) is notified to the spurious frame motion vector detector stage.

In case there are two or more maxima, the BMV position closest to zero vector at which the maxima histogram bar is detected is picked as the frame motion vector. In case of two maxima positioned at equal distance from zero BMV, the BMV position closest to past frame motion vector and nearest to zero BMV is picked as the frame motion vector from the histogram bars having maxima. If frame motion vector is detected from multiple maxima, a flag (spurious_{possible}) is notified to the spurious frame motion vector detector stage. In addition, the flag (spurious_{possible}) is notified if |frame motion vector| is positioned close to BMVmax or within the 15% limit of BMVmax.

Step 4: If the accumulated histogram based frame motion vector detection failed to pick the frame motion vector or the flag (spurious_{possible}) is set, then the filtered histogram based frame motion vector detection is triggered. frame motion vector is detected if filtered histogram yields a single maxima with maxima value more than or equal to a dynamic threshold ((b₀+b₁)×numBlk_{FiltHistThr}), where numBlk_{FiltHistThr} is the maximum of numBlk_{RawHistThr} or maxVal_{raw}. If the filtered maximum filtered histogram bar value is less than or equal to max_{raw}, then the flag (spurious_{possible}) is set.

Step 5: If flag (spurious_{possible}) is set by step 3 or step 4, or if the difference of frame motion vector detected at step 3 (if available) and step 4 is more than threshold (BMVmax/12) then set flag (spurious_{detected}). If flag (spurious_{possible}) is set by step 3 and difference of frame motion vector detected at step 3 and 4 is within threshold (BMVmax/12), use the frame motion vector from filtered histogram (step 4).

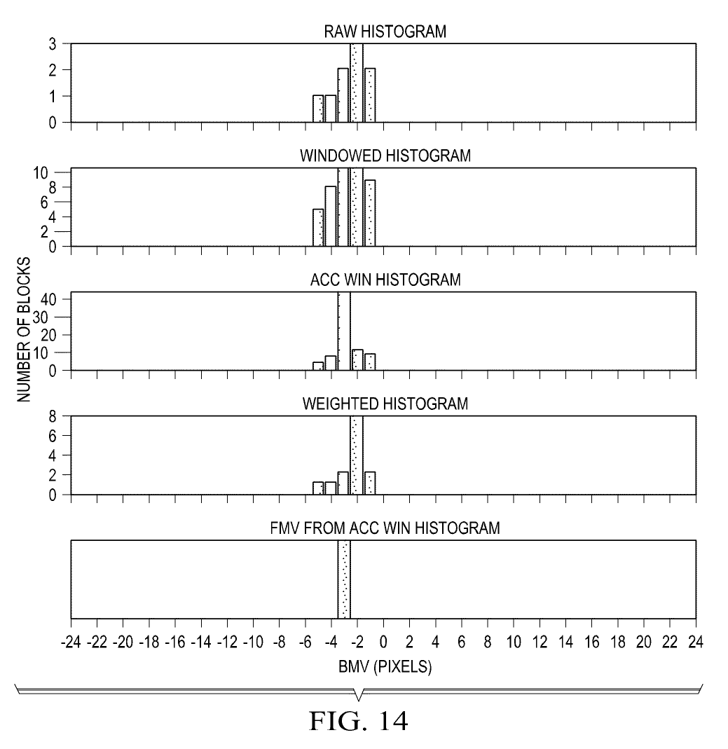

FIG. 14 provides an example of frame motion vector estimation using histograms in a frame. Extreme motion jitter compensation can be disabled by treating the estimated frame motion vector as zero. The extreme motion compensation disable facility passes frame motion vector as zero during the attenuation period in frame motion vector smoother. Extreme frame motion vector values may result due to flicker introduced luma variation across successive frames. Thus, this feature may be used in poorly tuned cameras where there will be flicker in image being captured under artificial lighting conditions.

If frame motion vector is not detected from the histograms or no BMVs are detected in current frame, the fame is marked as having no frame motion vector. In case of luminance variation on input frame, the boundary signals would have picked up the gain corresponding to Luma variation. Due to non-linearity in the sum of absolute differences computation, this would result in negative or positive slope sum of absolute differences vector or a sum of absolute differences vector having pseudo minimum. To avoid spurious frame motion vector due to Luma variation, several low computational measures are used to detect spurious frame motion vector
1) If the BMVs within a frame have larger variation across blocks and if the majority of BMVs are not close to each other, the frame is marked as not having frame motion vector. Otherwise, other methods described below are used for spurious frame motion vector detection.

If BMV variation within the frame (bmv_{range}) is more than the dynamic threshold (bmv_{Thr}) computed as in (10), and (11), BMV concentration is checked. If BMV concentration is not centered on estimated frame motion vector, the frame is marked as not having frame motion vector. A window (bmv_{DynamicThr}) is established around frame motion vector. The number of BMVs outside the window should be greater than the truncated value of number of BMVs inside the window scaled by 0.5 for the frame to be classified as not having frame motion vector.

$$\begin{matrix}b m {v}_{DynamicThr} [ n ] = max ( \begin{matrix}\begin{matrix}\begin{matrix}b m {v}_{DynamicThr}^{SF} \times \\ b m {v}_{DynamicThr} [ n - 1 ] ,\end{matrix} \\ b m {v}_{range}^{SF} \times \end{matrix} \\ max ( b m {v}_{range} [ n - m ] )\end{matrix} ) , \\ where \\ m = 1 , 2 , 3 , … , MAX\_PAST ( = 5 ) \\ n = current frame number \\ b m {v}_{range} [ n ] = b m {v}_{max} [ n ] - b m {v}_{min} [ n ] \\ b m {v}_{DynamicThr}^{SF} = 0.9 \\ b m {v}_{range}^{SF} = 1.25 & ( 10 ) \\ b m {v}_{Thr} [ n ] = saturate\_round ( \begin{matrix}b m {v}_{DynamicThr} [ n ] , \\ b m {v}_{Thr}^{max} , b m {v}_{Thr}^{min}\end{matrix} ) , \\ where \\ b m {v}_{Thr}^{max} = round ( 0.6 \times 2 \times B M {V}_{max} ) \\ b m {v}_{Thr}^{min} = round ( 0.35 \times 2 \times B M {V}_{max} ) & ( 11 )\end{matrix}$$

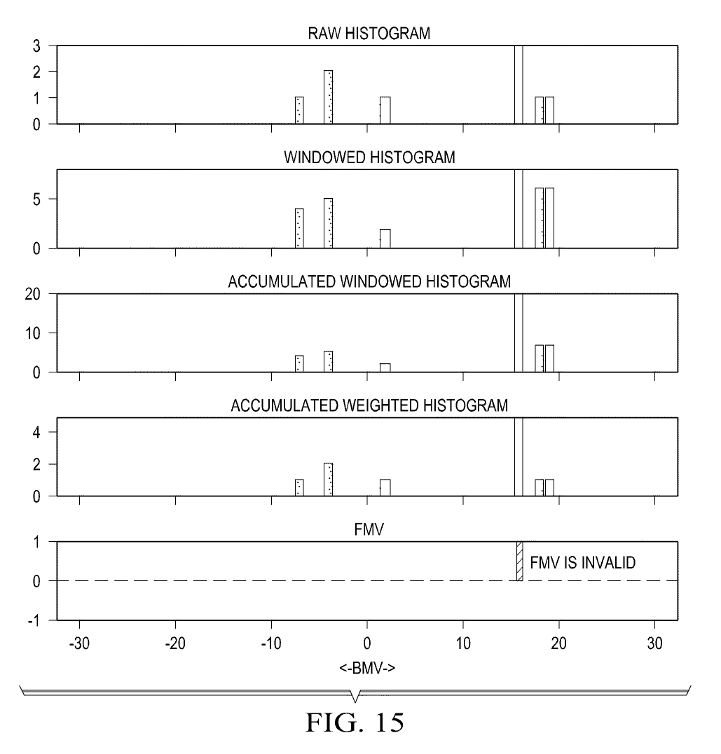

FIG. 15 is an example for spurious frame motion vector detection using this procedure.
2) If deviation of BMV within a frame (bmv_{range}) is more than dynamic threshold (bmv_{Thr}) and |FMV| is positioned close to BMVmax or within the 15% limit of BMVmax, the frame motion vector is marked as invalid. This method checks for positive or negative slope sum of absolute differences vector with high BMV deviation within frame to detect spurious frame motion vector.
3) If any of the frame motion vector in recent past (i.e. 5 past frames) is invalid and |frame motion vector| is positioned close to BMVmax or within the 15% limit of BMVmax, the frame motion vector is marked as invalid. If a frame is marked as invalid using this condition alone then the frame invalidity of this frame is not used for making the future frames invalid via this step.
4) If the number of BMVs outside the window is greater than the truncated value of number of BMVs inside the window scaled by 0.5 and |frame motion vector| is positioned close to BMVmax or within the 15% limit of BMVmax, the frame motion vector is marked as invalid. This step checks for number of BMVs closer to frame motion vector and high BMV deviation within a frame to detect spurious frame motion vector.

If any frame in the MAX_PAST past frames is invalid and |frame motion vector| is positioned close to BMVmax or within the 15% limit of BMVmax, the frame motion vector is marked as invalid. If only this condition decided the frame as INVALID, a flag is set to handle state update. This step looks for any one of the recent frames declared as invalid and high BMV deviation to decide current frame as invalid.
5) If a flag is set and |frame motion vector| is positioned close to BMVmax or within the 15% limit of BMVmax, the frame motion vector is marked as invalid.
6) If a flag is set, the frame motion vector is marked as invalid. This decision logic decided on the result being same (within a range) from filtered histogram and accumulated histogram.

If frame is not marked as invalid and frame motion vector is available for current frame, the frame motion vector is flagged as valid.

If any of the above steps forced a frame motion vector to be marked as invalid, a counter is incremented. Otherwise, the counter is reset. If the counter is more than or equal to the threshold (i.e. value of 2), the BMVs within a frame have smaller variation across blocks and the majority of BMVs are close to each other, then the state variables holding history of bmv_{range}[n−m] and bmv_{DynamicThr}[n−1] are updated.

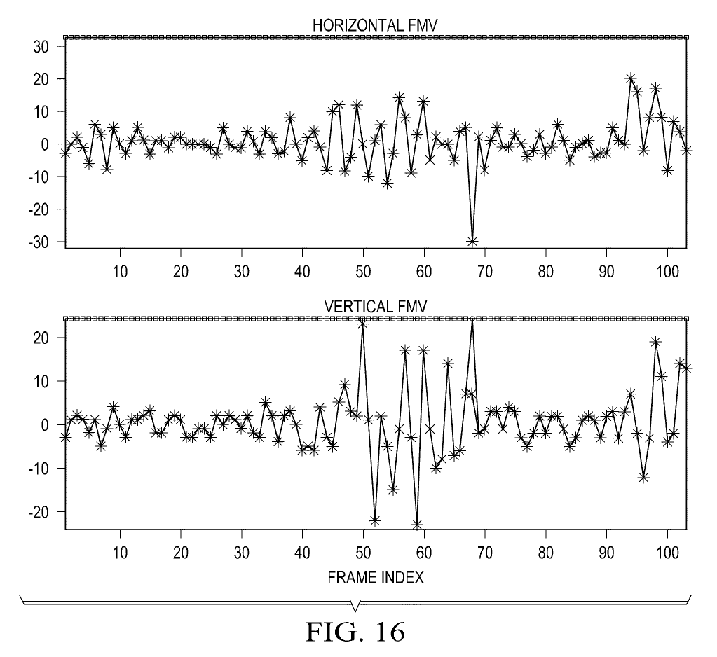

FIG. 16 shows the vertical and horizontal frame motion vector with spurious frame motion vector detection and smoothing at frame number 68 for vertical frame motion vector. Each of the conditions for detecting spurious FMV may be disabled or enables independently or collectively with any possible combination, depending on the nature of video input.

Frame motion vector smoother gradually increases attenuation of previous valid frame motion vector for use as current frame motion vector where current frame motion vector is invalid. The attenuation is carried out until the frame motion vector reaches 0. This step can possibly avoid jitter in output stabilized frame when current frame motion vector is invalid and takes as 0. In addition, this logic gradually releases attenuation on transition from invalid frame motion vector to valid frame motion vector to avoid possible jerks.

FMV smoother may be disabled if not needed by the application scenario. Since the smoother is preferred to be present at output stabilization coordinate, the default may be to disable the smoother. The main purpose of the smoother at disabled state is to detect spurious FMV which are not detected by spurious FMV detector.

The computation steps are as follows:
1) If a frame motion vector is invalid, the last valid frame motion vector is gradually attenuated, i.e. until the frame motion vector reaches 0. The attenuations factors may be 1, 0.75, 0.5, 0.25 and 0. The attenuation may gradually be increased (attenuation factor is decreased) on each successive invalid frame until the frame motion vector reaches 0.
2) In case of a valid frame motion vector when the attenuation is in progress or if any one of the past N (5) frame motion vector was invalid, and if the frame motion vector deviation (fmv_{diff}) between current frame motion vector and previous frame motion vector is above the dynamic threshold (fmv_{DynamicThr}) then the frame motion vector attenuation is continued using previous valid frame motion vector. The frame motion vector of current frame is treated as invalid. The dynamic threshold is computed as in (12) and (13).

$$\begin{matrix}f m {v}_{DynamicThr} [ n ] = max ( \begin{matrix}\begin{matrix}\begin{matrix}f m {v}_{DynamicThr}^{SF} \times \\ f m {v}_{DynamicThr} [ n - 1 ] ,\end{matrix} \\ f m {v}_{range}^{SF} \times \end{matrix} \\ max ( f m {v}_{diff} [ n - m ] )\end{matrix} ) , \\ where \\ m = 1 , 2 , 3 , … , MAX\_PAST ( = 5 ) \\ n = current frame number \\ f m {v}_{diff} [ n ] = f m v [ n ] - f m v [ n - 1 ] \\ f m {v}_{DynamicThr}^{SF} = 0.9 \\ f m {v}_{range}^{SF} = 1.5 & ( 12 ) \\ f m {v}_{Thr} [ n ] = saturate\_round ( \begin{matrix}f m {v}_{DynamicThr} [ n ] , \\ f m {v}_{Thr}^{max} , f m {v}_{Thr}^{min}\end{matrix} ) , \\ where \\ f m {v}_{Thr}^{max} = round ( 0.8 \times 2 \times F M {V}_{max} ) \\ f m {v}_{Thr}^{min} = round ( 0.4 \times 2 \times F M {V}_{max} ) & ( 13 )\end{matrix}$$

In case of disabled state, the frame motion vector is marked as invalid if any of the past N frame motion vector was invalid and if the frame motion vector deviation between current frame motion vector and previous frame motion vector is above the dynamic threshold.
3) If the frame motion vector deviation (fmv_{diff}) is less than or same as the dynamic threshold (fmv_{DynamicThr}) and attenuation is in progress, then the attenuation is gradually removed until the attenuation factor reaches unity. The attenuation factor is applied on current frame valid frame motion vector. The frame motion vector of current frame is treated as valid in this case.

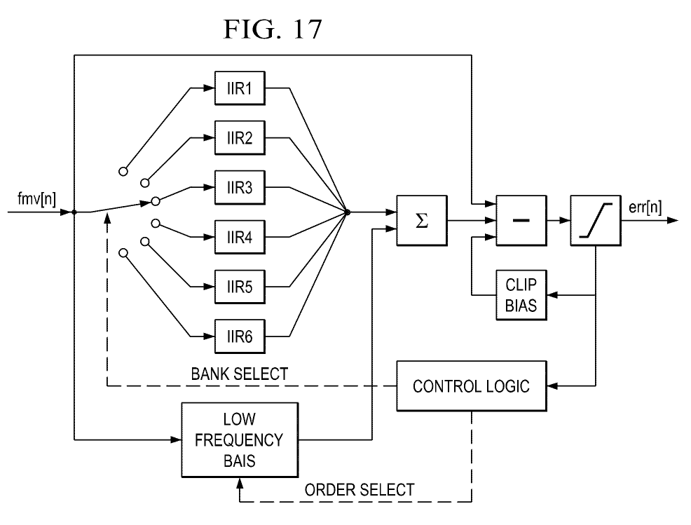

In this stage, the unwanted motion of the frame is estimated. The unwanted motion is converted into (x,y) coordinates of the top-left corner of the current frame that is to be used for cropping by FMC. The block diagram is shown in FIG. 17. The UME module consists of a bank of biquad filters, Low Frequency Bias, Clip Removal Bias, Control logic, and output formatter. The biquad filters are used for smoothing the frame motion vector signal. The smoothed signal is used for estimating motion jitter. Different orders of filter are used so as to filter out the jitter to different levels.

For example, panning (motion is intentional) image sequence need to track fast and steady shots (no desired motion) may not require tracking. Low Frequency Bias module, consisting of averaging filter, is used for compensating any delay introduced by biquad filters which may result in error in tracking/compensation. Control logic is used for tuning the biquad filter parameters (filter selection) and Low Freq Bias module (order of averaging filter). Since allowable motion compensation is limited by the amount pixels excluded from original frame during cropping, the jitter to be compensated is limited to a threshold. To minimize the effect of clipped jitter compensation, a steady bias component is generated using Clip Removal Bias module.

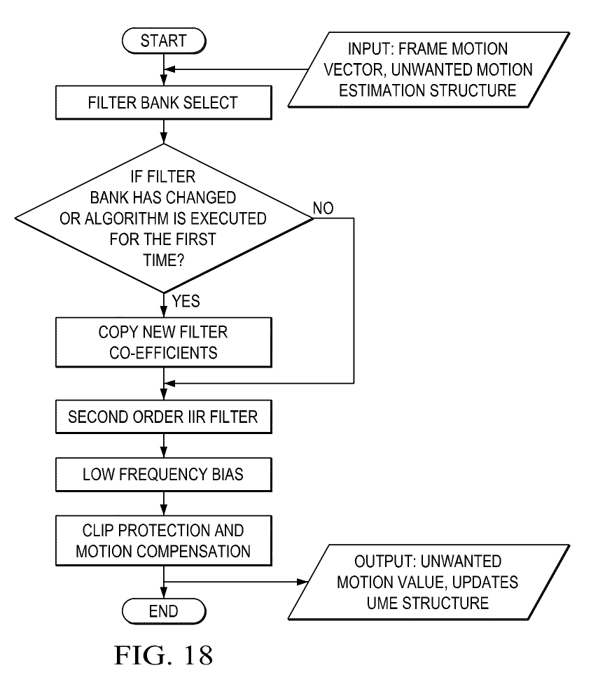

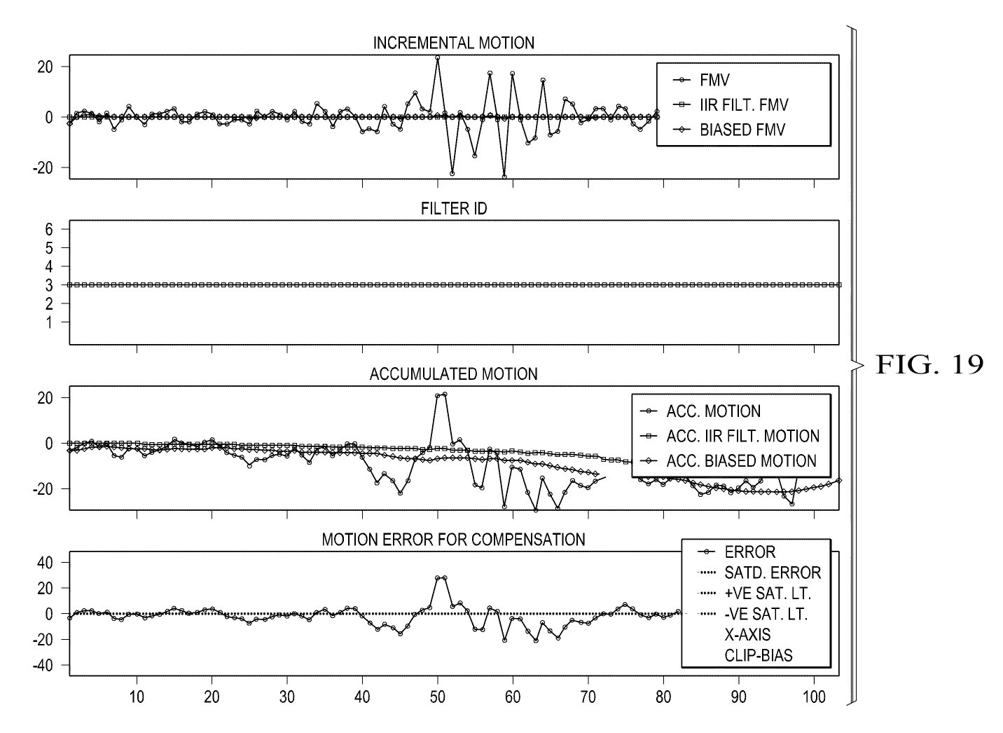

FIG. 19 illustrates the functioning of jitter motion compensation using all the waveforms processed inside UME. The computational steps in UME flowchart as shown in FIG. 18 are:
Step1: Estimate if the filter bank needs to be changed.
Step2: If the filter bank changes, the filter coefficients are copied from the filter bank.
Step3: The frame motion vector obtained from previous stage is passed through a 2^{nd} order IIR filter.
Step4: Low frequency bias is computed.
Step5: Motion to be compensated is computed. The co-ordinates for cropping the window are computed. Clip protection is done for the co-ordinates if the cropping window is large.

If frame motion vector is invalid, UME stage is bypass. The UME stage retains the state so that the previously used compensation coordinates is retained. This is essential to avoid any jerks introduced by the algorithm when frame motion vector estimation is inaccurate, which is the inherent jitter in stream passed through when frame motion vector is invalid.

If the frame motion vector is invalid for two (2) consecutive frames, the UME IIR filter state ad settling times are reset. All other parameters, like filter selection, low frequency bias and lip protection, are retained as that of the most recent frame having a valid frame motion vector.

In cases where frame motion vector is invalid for more than specified number of frames (N=6) consecutively, the states of BME, FME and UME are reset to initial values. If the consecutive frame invalid is due to disabling of extreme jitter compensation, FME parameters only are reset.

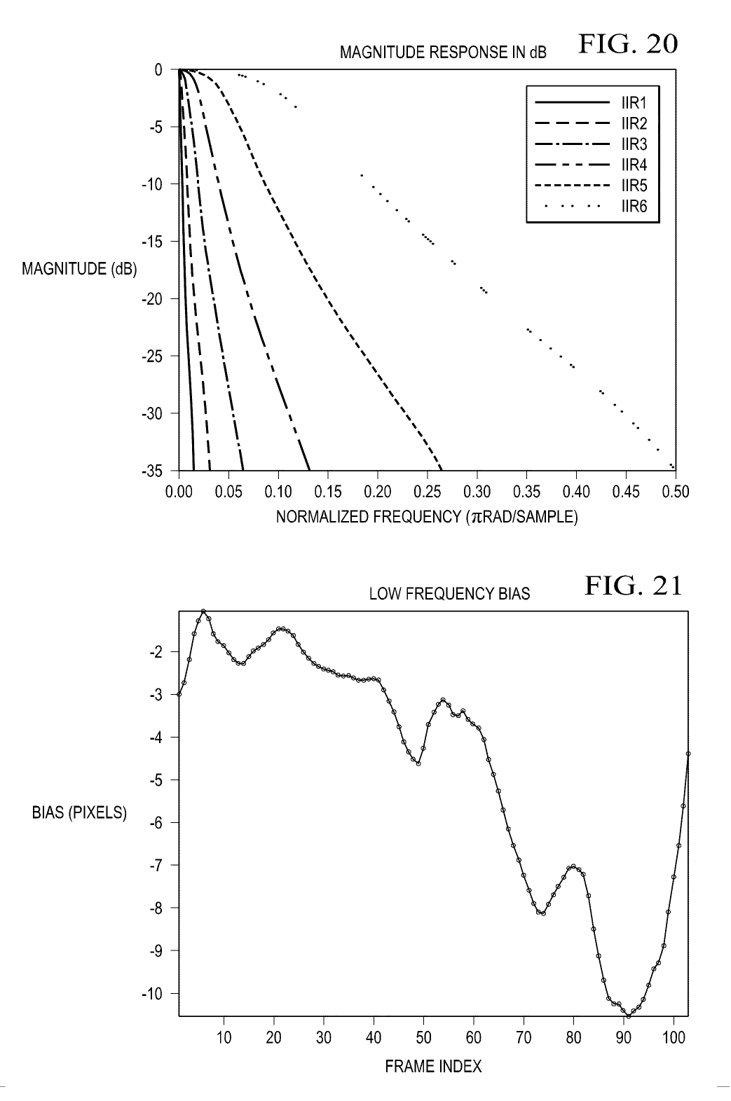

Second order (biquad) IIR filters with frequency responses as shown in FIG. 20 are used for building the Filter Bank.

The filter is implemented as in (14).

a0×y[n]=b0×x(n)+b1×x(n−1)+b2×x(n−2)−a1×y(n−1)−a2×y(n−2), (14)

where b0, b1, b2, a0, a1, a2 are filter coefficients

The coefficients {b0, b1, b2, a0, a1, a2} of the filters are as follows:

{1.768435e−002, −3.527182e−002, 1.768435e−002,
1.0000000e+000, −1.986156e+000, 9.862525e−001}, // IIR1
{1.763447e−002, −3.488359e−002, 1.763447e−002,
1.0000000e+000, −1.972291e+000, 9.726761e−001}, // IIR2
{1.767785e−002, −3.382677e−002, 1.767785e−002,
1.0000000e+000, −1.944431e+000, 9.459598e−001}, // IIR3
{1.833034e−002, −3.058438e−002, 1.833034e−002,
1.0000000e+000, −1.887696e+000, 8.937721e−001}, // IIR4
{2.207892e−002, −1.908483e−002, 2.207892e−002,
1.0000000e+000, −1.765662e+000, 7.907348e−001}, // IIR5
{4.104093e−002, 2.736051e−002, 4.104093e−002,
1.0000000e+000, −1.483873e+000, 5.933153e−001} // IIR6

The cut-off frequencies of the low pass filters are at [0.5/30; 1/30; 2/30; 4/30; 8/30; 15/30], with 1.0 corresponding to half the sample rate. Chebyshev type II order filter with attenuation of 35 dB is used to achieve faster roll-off.

The settling time of the filters are [680; 340; 170; 84; 42; 21] samples respectively. The IIR1 filter is ideal for steady shots with motional jitter and IIR6 is best suited for high panning motion with jitter. When the pass band is narrow, filter response is slow and settling time is large. When the pass band is wide, filter response is fast and settling time is low. Generally the filter is switched to new parameters only when the current filter is in steady state.

If the filter has reached steady state and if there was any clipping of jitter compensation during the filter transience period, the filter cutoff frequency is increased. For example, selection is changed from IIR3 to IIR4. During cut-off frequency change, the previous filter stage state is retained to minimize transience state in the new filter stage. If the current filter is IIR1 or IIR2 during which clipping occurred, and if the filter has exceeded settling time of IIR3 filter then the filter is switched directly to IIR4. This is done to avoid large period of clipping caused by tight control. For example, a steady state shot may suddenly transition to panning motion and the filter switch may be needed sooner to minimize the amount of clipping caused by start of panning due to tight tolerances of the IIR1 and IIR2.

If the filter has reached steady state and if there was no clipping during the filter transience, the cut-off frequency of the filter is decreased. For example the filter selection is changed from IIR3 to IIR2. The filter states are unaltered during the switching.

The abovementioned filter switching procedure is repeated until the least or highest cut-off frequency is reached. The filter switching logic is active throughout the duration of motion jitter stabilization.

The low frequency bias is estimated using an averaging filter on the difference between the actual motion (accumulated frame motion vector) and absolute motion (accumulated IIR output). The difference is a low frequency bias caused by lag in IIR filter and filter switching. This difference when exceeds a limit will cause saturation of motion jitter compensation. The purpose of low frequency bias is to avoid saturation while being able to provide effective jitter removal. The stage reduces the motion lag caused by the 2^{nd} order filter during panning sequences and intentional motion of the camera.

The averaging filter order is dynamically computed based on whether motion compensation is saturated. On start up the filter order gradually increases from 1 to max order (32). In case the absolute motion compensation vector is more than threshold (BMVmax/16) and the counter tracking this event reaches a limit (16), the filter order is decreased by 1 on each frame. The minimum order is limited to a minimum limit (4). Similarly if the counter is 0, the order is increased until the order reaches the maximum allowed (32). The counter is incremented each time the motion compensation vector has same sign and exceeds the threshold (BMVmax/16) or if there is no clipping of motion compensation vector. The counter is less than the limit (16) and if the previous and current frame motion compensation factor were more than threshold (BMVmax/16) on opposite directions, the counter is set to 0. Otherwise, the counter is decremented by 1.

FIG. 21 is an example of low frequency bias waveform. The computational steps are as follows:

The absolute motion from FME stage (AbsoluteMotion) is obtained by summing all frame motion vectors as shown in (15). Similarly the absolute motion of IIR output (AbsoluteFilterMotion) is obtained as shown in (16).

$$\begin{matrix}AbsoluteMotion = {{\sum }_{0}}^{Present} F M V , \\ where frame motion vector is input to IIR filter & ( 15 ) \\ AbsoluteFilterMotion = {{\sum }_{0}}^{Present} FiltOut , \\ where FiltOut is output from IIR filter & ( 16 )\end{matrix}$$

The absolute motion and absolute filter motion are prevented from overflowing over time by subtracting a common factor (cf) from both variables as shown in (17). The subtraction factor is the minimum integer value among both variables.

cf=min(AbsoluteMotion, floor(AbsoluteFilterMotion))

AbsoluteMotion=AbsoluteMotion−cf

AbsoluteFilterMotion=AbsoluteFilterMotion−cf (17)

The difference (Diff) between AbsoluteMotion and AbsoluteFilterMotion is stored in a circular buffer of length equal to the maximum order of the averaging filter (32).

Diff[n]=AbsoluteMotion−AbsoluteFilterMotion (18)

The low frequency bias is computed by taking the average of available samples in the LFB array and averaging the obtained value with the previous value of low frequency bias.

$$L F B [ n ] = \frac{\frac{1}{order} \times {\sum }_{m = 0}^{m = order - 1} Diff [ n - m ] + L F B [ n - 1 ]}{2} , \\ where order = order of averaging filter \qquad ( 19 )$$

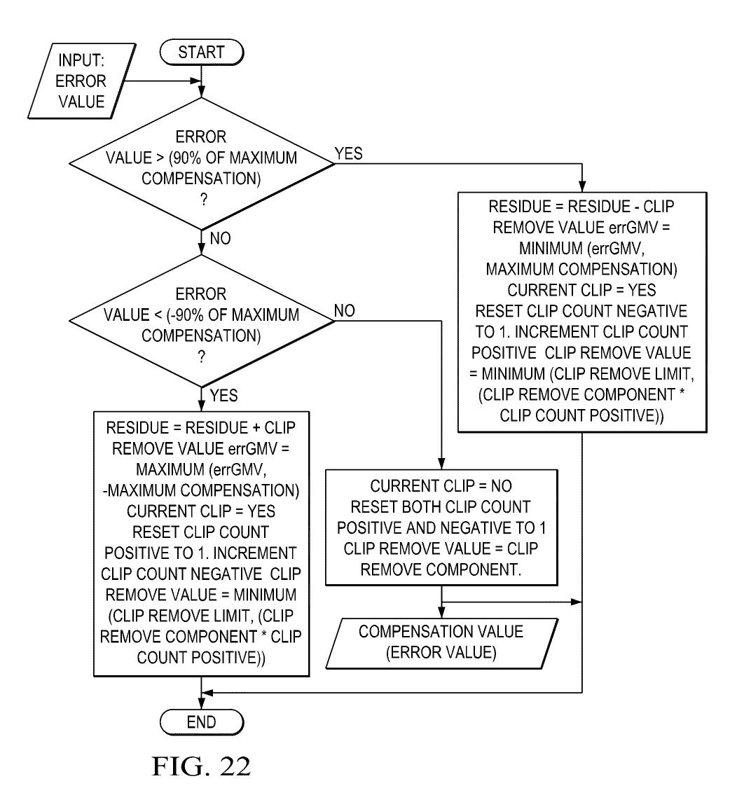

If the motion compensation vector is more than 90% of the compensation limit, clip removal bias is used to minimize the effect of clipping as shown in FIG. 22. The minimum and maximum threshold clip removal bias are 0 and 2*BMVmax/12 respectively. The clip removal bias least count is 2*BMVmax/48. On each consecutive frame that needs clip removal bias in the same direction, the clip removal bias (ClipBias) is linearly increased as shown in (20). The sign of ClipBias (sign) is opposite in sign of motion compensation vector. For example, if negative clipping on motion compensation apply positive clip removal bias.

$$ClipBias = sign \times max ( \begin{matrix}numClips \times \frac{2 \times B M {V}_{max}}{48} , \\ \frac{2 \times B M {V}_{max}}{12}\end{matrix} ) , \\ where \\ numClips is the number of consecutive frames exceeding \\ motion compensation limit in the same direction \qquad ( 20 )$$

The error value or compensation vector (Err) is computed as shown in (20). The error or compensation vector on vertical and horizontal direction can be mapped to compensation coordinate for stabilization.

Err[n]=AbsoluteMotion[n]−AbsoluteFiltMotion[n]−LFB[n]+ClipBias[n] (20)

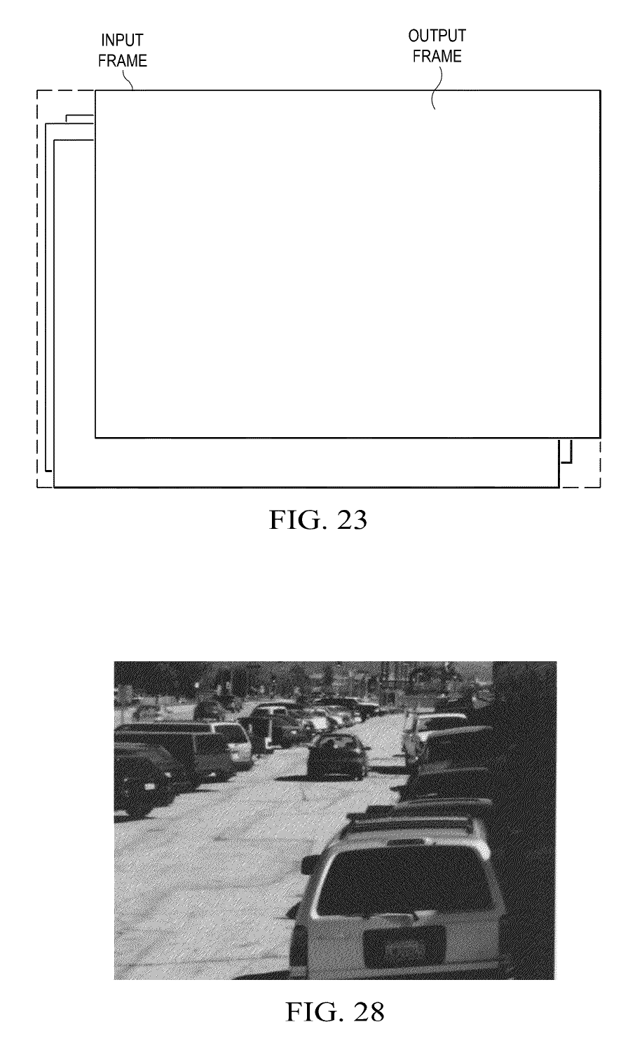

The simplest FMC can be cropping of the window for display from the captured frame. The captured frame is larger than the window being recorded or displayed, large enough to allow for FMC as shown in FIG. 23. By changing the coordinate (h, v) for window start position, the unwanted motion can be compensated. The window is positioned in the opposite direction of the jitter for compensation. The horizontal window position can be adjusted to nearest even pixel to avoid chroma sample reversal, as can be seen from chroma sample arrangement YC_{b}YCᵣYC_{b}YCᵣ . . . in YC_{b}Cᵣ 422 format.

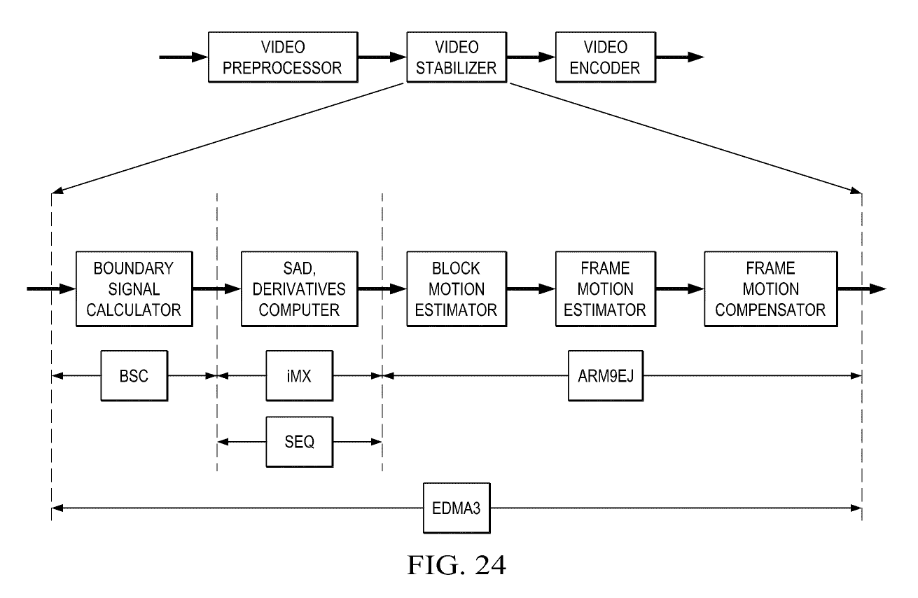

In some processor when performing fixed point computations, the BSC amounts to 69% of computational load, sum of absolute differences computation is 25%, and BME and FME computation is remaining 6%. The BSC, sum of absolute differences and Motion Estimation (ME) computations may utilize 51 MHz and 200 MHZ for (Quarter VGA) QVGA and (Video Graphics Array) VGA respectively. This necessitates hardware acceleration for performing BSC and sum of absolute differences computation as shown in FIG. 24. For example, some processors, such as, DM355 System on a Chip (SoC) for DSC, provides Boundary Signal Calculator (BSC) hardware accelerator and programmable SIMD image processing engine (iMX) for BS and sum of absolute differences computations respectively. Though BS computation can be performed using iMX, BSC is efficient and offloads iMX engine. The task of scheduling and triggering iMX execution and Direct Memory Access (DMA) peripheral is handled by programmable Sequencer (SEQ) to offload control code from ARM9EJ involved in managing the coprocessors and accelerators.

For example, some processor may include ARM9EJ core for BME and FME. ARM9EJ is efficient in performing control related code like BME and FME. If cropping is needed for FMC, iMX can be used for rearrangement of data as may be required in YC_{b}Cᵣ 422 format. In case of window position adjustment in YC_{b}Cᵣ 422 format image sequence, the odd horizontal pixel position will reverse the C_{b} and Cᵣ position in YC_{b}YCᵣYC_{b}YCᵣ . . . sample sequence. Interpolation of adjacent pixels, on iMX, can be used to estimate the chroma samples.

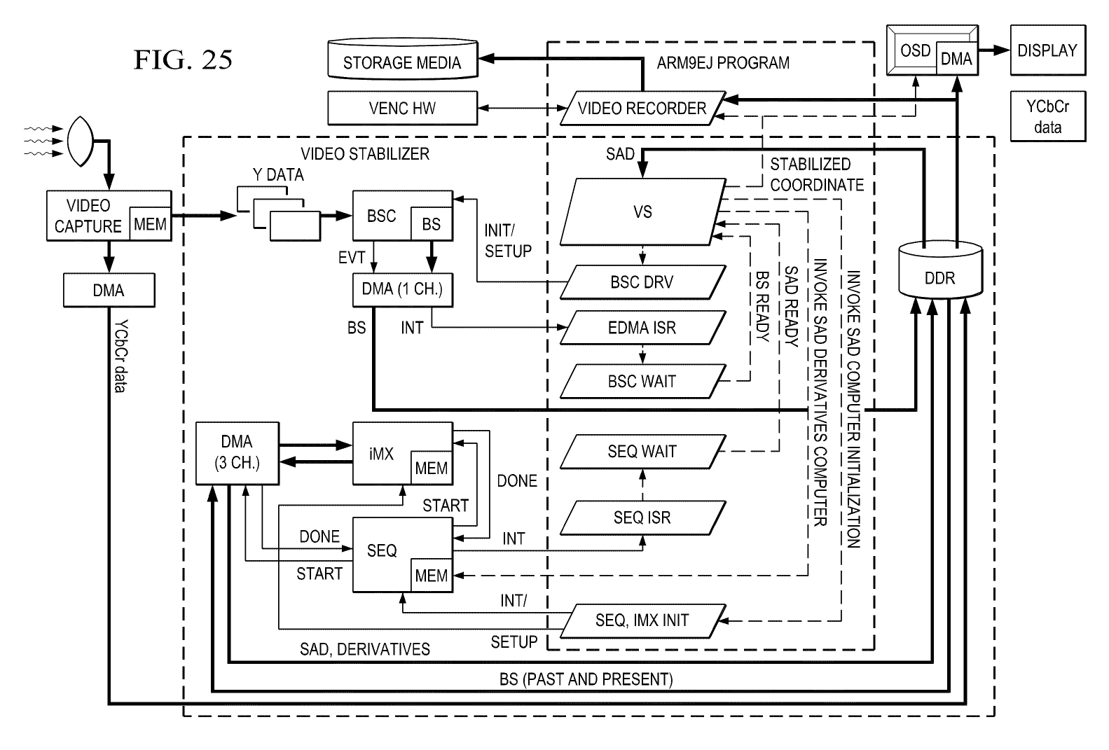

The image stabilizer apparatus is shown in FIG. 25. The Y samples of the frames are advanced one pixel at a time to BSC. The BSC performs accumulation of Y samples horizontally and vertically to generate BS in memory residing in BSC module. BSC can be programmed to generate one or more boundary signals vertically and horizontally. The generated boundary signal can be divided horizontally or vertically for vertical and horizontal boundary signals respectively to produce N×N block division. The computation of BSC is stopped for last few lines of the frame in order to allow for copying of BS to DDR. The BSC generates completion INT which triggers DMA transfer of BS to DDR. On transfer completion, DMA generates INT to ARM9EJ.

The ISR triggers image stabilization algorithm to initiate sum of absolute differences computation using iMX. Once the sum of absolute differences computation is initiated, the ARM9EJ is free to do other functions. An RTOS scheduler can schedule next task. One sum of absolute differences vector is computed per execution of iMX program. The 1^{st} and 2^{nd} derivatives are computed for each sum of absolute differences vector. In addition, the minimum sum of absolute differences position, minimum and maximum sum of absolute differences value, and maximum 2^{nd} derivative position are computed using iMX. The positions are used for estimating BMV. The maximum sum of absolute differences value is used for estimating dynamic right shift value to be applied to sum of absolute differences vector for next frame.

When iMX is processing data in one image buffer, DMA is fetching input for next sum of absolute differences vector computation into second iMX buffer. In the mean time, the previous result is transferred to DDR from the third iMX buffer. The buffers cyclically switch to avoid any waits for input data fetch or output data store before executing next iMX program. Thus, the input BS data fetch for next sum of absolute differences computation, current sum of absolute differences computation, and past sum of absolute differences result store are happening concurrently. When DMA and iMX are performing their functions, SEQ is waiting for completion sync of DMA and iMX. On receiving completion sync, SEQ switches the buffers cyclically and initiates DMA transfers and starts iMX program. On completion of sum of absolute differences computation, SEQ INT ARM9EJ and VS algorithm is ready to run again. Now rest of computation is carried out in ARM9EJ to find image stabilization coordinates. The coordinates are passed onto image recorder and image display threads.

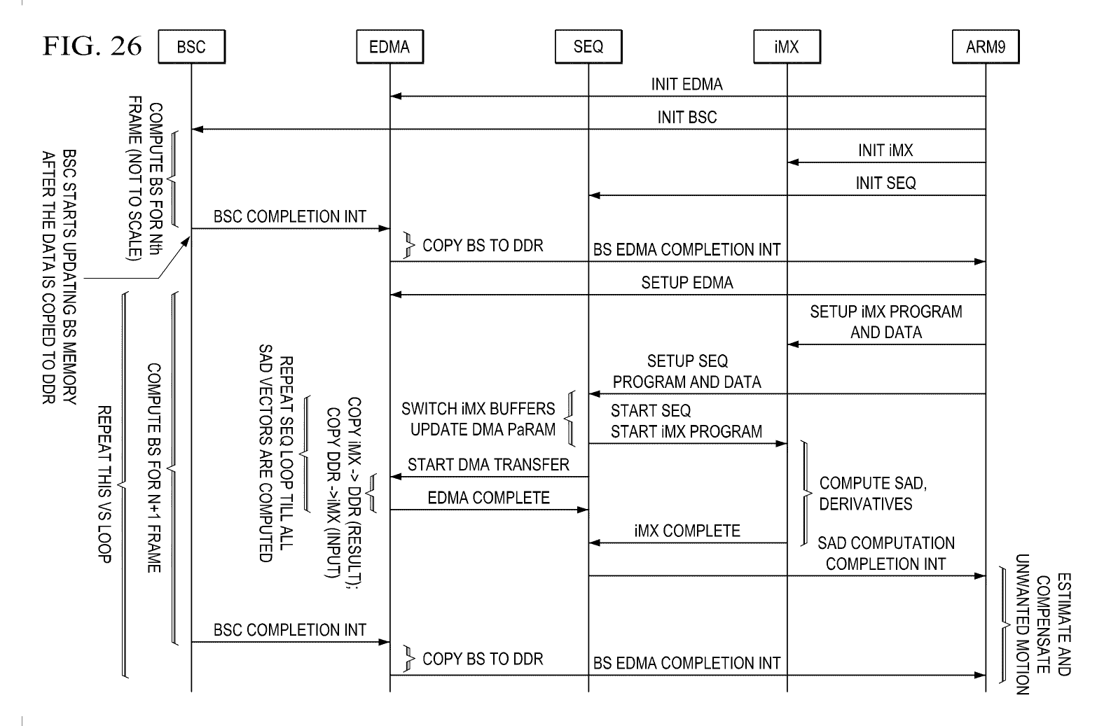

FIG. 26 illustrates the sequence of events during stabilization progress. The BSC hardware is active for most of the time except when the BS data is being copied to DDR. The SEQ and iMX programs are briefly active to perform sum of absolute differences computation. The SEQ and iMX hardware can be multiplexed to perform image/video encode, noise filter, etc when not in use by image stabilizer. ARM9EJ is active for a short time to perform block motion estimation, frame motion estimation and coordinate computation for compensating unwanted motion.

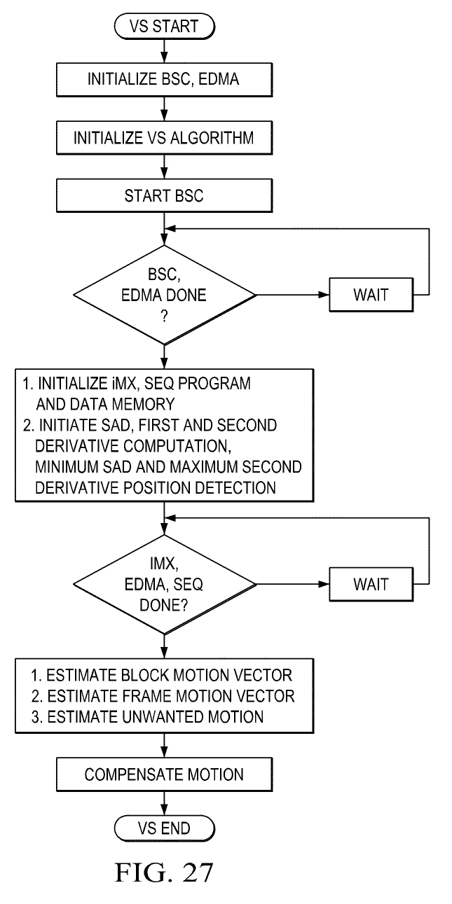

The flowchart in FIG. 27 provides a top level view of the ARM9 program utilized in image stabilizer. The program initializes BSC, DMA, SEQ and iMX hardware. Once the image stabilization is enabled, the BSC hardware is started. On receiving EDMA transfer completion of BS signal, the SEQ and iMX program and data memory are initialized. Then, ARM transfers control to SEQ. On completion of sum of absolute differences computation, SEQ signals VS algorithm in ARM9EJ to estimate unwanted motion. ARM9EJ performs block and frame motion estimation, and compensates unwanted motion by outputting start co-ordinates of the top-left corner of the frame. In addition, the stabilizer output frame motion vector and maximum BMV of each frame. These output parameters maybe provided as input for image stabilization for detecting any object or frame movement.

Table I illustrates the stabilization quality measurement of images containing known motion jitter. The stream is well illuminated scene with automobiles and a train moving in a small area of the scene. One frame of the 640×480 stream is shown in FIG. 28.

TABLE I
IMAGE STABILIZATION QUALITY

| | | Jitter | Stabilization | Stabilization |
|---|---|---|---|---|
| Jitter | Stream | Magnitude | Error* | Ratio** |
| Type | Description | (pixels/frame) | (pixels/frame) | (%) |
| Constant | Horizontal jitter | +/−31 | 0 | 0 |
| Constant | Vertical Jitter | +/−23 | 0 | 0 |
| Random | Jitter in both directions | Varying | 1 | 0 |
| Random | Vertical panning with jitter | +/−12 (max) | 3 | 4. |
| | in both directions. Varying | | | |
| | with pane of 4 pixels. | | | |
| Random | Horizontal panning with | +/−16 (max) | 2 | 0 |
| | jitter in both directions. | | | |
| Random | Diagonal panning with jitter | +/−12 (max) V | 3 | 5 |
| | in both directions. Varying | +/−16 (max) H | | |
| | with pane of 4 pixels. | | | |
| Constant | Vertical Jitter | +/−24 | 1 | 0 |
| Constant | Horizontal Jitter | +/−32 | 1 | 0 |

$* Error = \frac{1}{200} {\sum }_{1}^{200} ( jitter - ( - compensation ) ) ; Total number of frames = 200.$ $** Stabilization ratio = 100 \times \frac{Number of frames not stabilized}{Total number of frames \text{(=200)}}$

Table II illustrates the improvement in performance of the image stabilizer with respect to ARM9EJ with data cache and instruction cache. The use of BSC and iMX offloads ARM9EJ processing load by 69% and 27% respectively. Note that ARM is free to execute any task while iMX is performing sum of absolute differences computation

TABLE II
IMAGE STABILIZATION PERFORMANCE ARM9EJ VS DM355

DM355

| | ARM9EJ | ARM9EJ | iMX, SEQ |
|---|---|---|---|
| Resolution | (MHz) | (MHz) | (MHz) |
| 640 × 480 @ 30 fps | 200 | 5.184 | 5.054 |

Thus, the histogram of all the block motion vector in a frame, sliding window on raw histogram, neighborhood accumulated histogram on windowed, and weighted accumulated histogram based on past frame histograms aid in better global motion estimation. The spurious data handling minimizes the global motion estimation induced jitter that is caused due to scene change, Luma variation, and object motion effectively. Thus, the precise control using variable cut-off low pass filter aids in maximum motion jitter removal. The averaging filter of variable order eliminates the delay introduced by the low pass IIR filter and minimizes the control lag and clipping. The effect of clipping even if present is minimized by the use of dynamically computed steady bias. This helps in better stabilization result when the difference of cropped area to frame area is smaller. The tests carried out with synthetic and natural images/videos (about 175 streams of average 500 frames per stream), validate the above theory.

The computational efficiency is achieved by the use of hardware accelerator/coprocessors for projection vector (boundary signal), and sum of absolute differences vector and its derivatives computations. With the aid of sequencer (SEQ) hardware and use of enhanced DMA ARM9 is freed up from control and data transfer activities. The ARM9 is used for very small amount of time for control algorithms and filter. The use of accelerators allows the clock frequency to be lower. In addition, ARM9 (GPP) is offloaded for carrying out other application tasks when accelerators are functioning. Since the accelerators execution time is constant for boundary signal generation, the algorithm execution speed is same for all resolution images. In case of frames of resolution higher than 640×480, the accelerator down-samples the spatial data before computing projection vector. This means the stabilization quality maybe sacrificed whilst maintaining the clock frequency the same for resolutions greater than 640×480.

While the foregoing is directed to embodiments of the present invention, other and further embodiments of the invention may be devised without departing from the basic scope thereof, and the scope thereof is determined by the claims that follow.

What is claimed is:

1. A translation motion stabilization method of a digital signal processor for video, comprising:
initializing clip bias estimation and programmable sequencer;
calculating sum of absolute differences and sum of absolute differences derivatives;
utilizing the clip bias estimation, programmable sequencer, sum of absolute differences and sum of absolute differences derivatives to estimate block motion vector, frame motion vector and unwanted motion vector; and
compensating for motion to produce a stabilized video.

2. The method of claim 1, wherein only 1^{st} and 2^{nd} derivatives of sum of absolute differences are calculated.

3. The method of claim 1 further comprising initializing at least one of a boundary signal computation and enhanced direct memory access.

4. The method of claim 1 further comprising determining the unwanted motion vector value.

5. The method of claim 4, wherein determining the unwanted motion vector value comprises:
selecting a filter bank;
copying a new filter bank, if the filter bank changed or if first time utilized;
utilizing the filter bank 2^{nd} order IIR filter, low frequency bias, clip protection and motion estimation to determine the unwanted motion vector value; and
updating a structure with the unwanted motion vector value.

6. A translation motion stabilization apparatus for video, comprising:
means for initializing clip bias estimation and programmable sequencer;
means for calculating sum of absolute differences and sum of absolute differences derivatives;
means for utilizing the clip bias estimation, programmable sequencer, sum of absolute differences and sum of absolute differences derivatives to estimate block motion vector, frame motion vector and unwanted motion vector; and
means for compensating for motion to produce a stabilized video.

7. The method of claim 6, wherein only 1^{st} and 2^{nd} derivatives of sum of absolute differences are calculated.

8. The method of claim 6 further comprising means for initializing at least one of a boundary signal computation and enhanced direct memory access.

9. The method of claim 6 further comprising means for determining the unwanted motion vector value.

10. The method of claim 9, wherein the means for determining the unwanted motion vector value comprises:
means for selecting a filter bank;
means for copying a new filter bank, if the filter bank changed or if first time utilized;
means for utilizing the filter bank 2^{nd} order IIR filter, low frequency bias, clip protection and motion estimation to determine the unwanted motion vector value; and
means for updating a structure with the unwanted motion vector value.

11. A computer readable medium comprising software that, when executed by a processor, causes the processor to perform a method for translation motion stabilization, the method comprising:
initializing clip bias estimation and programmable sequencer;
calculating sum of absolute differences and sum of absolute differences derivatives;
utilizing the clip bias estimation, programmable sequencer, sum of absolute differences and sum of absolute differences derivatives to estimate block motion vector, frame motion vector and unwanted motion vector; and
compensating for motion to produce a stabilized video.

12. The method of claim 11, wherein only 1^{st} and 2^{nd} derivatives of sum of absolute differences are calculated.

13. The computer readable medium of claim 11 further comprising initializing al least one of a boundary signal computation and enhanced direct memory access.

14. The computer readable medium of claim 11 further comprising determining the unwanted motion vector value.

15. The computer readable medium of claim 14, wherein determining the unwanted motion vector value comprises:
selecting a filter bank;
copying a new filter bank, if the filter bank changed or if first time utilized;
utilizing the filter bank 2^{nd} order IIR filter, low frequency bias, clip protection and motion estimation to determine the unwanted motion vector value; and
updating a structure with the unwanted motion vector value.
